(19) United States
(12) Patent Application Publication
(10) Pub. No.: US 2021/0371688 A1
(43) Pub. Date: Dec. 2, 2021

(54) FIBER IDENTIFICATION WITH PHOTOREACTIVE MARKING COMPOUNDS

(71) Applicant: CORNING INCORPORATED, Corning, NY (US)

(72) Inventors: Hector Michael Belleza De Pedro, Painted Post, NY (US); Stephan Lvovich Logunov, Corning, NY (US); Joseph Doull Thaler, Corning, NY (US)

(21) Appl. No.: 17/330,914

(22) Filed: May 26, 2021

Related U.S. Application Data
(60) Provisional application No. 63/030,969, filed on May 28, 2020.

(51) Int. Cl. C09D 11/50; C09D 11/107; C03C 13/04; G02B 6/44; G02B 6/02; C03C 25/106; C03C 25/36; B41J 2/475

(52) U.S. Cl. CPC C09D 11/50; C09D 11/107; C03C 13/04; G02B 6/447; C03C 2213/00; C03C 25/106; C03C 25/36; B41J 2/475; G02B 6/02395

(57) ABSTRACT

An optical fiber having a coating that includes a photoreactive marking compound is described. The photoreactive marking compound has two states that differ in the intensity and/or wavelength of fluorescence. Exposure of the photoreactive marking compound to electromagnetic radiation induces a transformation of the photoreactive marking compound from one state to the other state. The difference in fluorescence between the two states provides a detectable contrast that can be used to mark the optical fiber. A pattern of marks can be customized to different optical fibers to provide unambiguous identification of individual fibers. The coating may also include a pigment, where either or both of the pigment and photoreactive marking compound may function as a marker for identifying the optical fiber. The method extends generally to marking of films, coatings, and articles made of polymers or plastics.

This application claims priority under 35 USC § 119(e) from U.S. Provisional Patent Application Ser. No. 63/030,969 filed on May 28, 2020 which is incorporated by reference herein in its entirety.

### FIELD

This disclosure pertains to optical fibers and in particular relates to methods and apparatus for marking optical fibers. More particularly, the disclosure pertains to marking of optical fibers using photoreactive marking compounds.

### BACKGROUND

Optical fibers are widely used in the telecommunications and data transmission industries. The need for faster data transfer rates and greater bandwidth is motivating the development of new fibers with better performance characteristics. A common strategy for increasing data transmission is to bundle multiple optical fibers in a cable. To increase data transmission, it is desirable to maximize the number of optical fibers bundled in a cable. During use and installation of cables, it is often necessary to join multiple cables together to increase cable length to meet the needs of an application. Since each fiber in a bundle is dedicated to a distinct data channel, it is necessary to identify individual fibers in a bundle to insure proper connection of data channels when cables are joined.

Identification of fibers is typically accomplished by marking fibers associated with different data channels with different colors. The marking can be accomplished by applying ink layers with different colors to individual fibers to mark them. The ink layers are typically curable compositions that include color pigments. A series of colors for marking fibers has been approved as standards in the telecommunications industry. The color standards include blue, orange, green, brown, slate, white, red, black, yellow, violet, rose and aqua. Since the number of standardized colors is limited, it becomes increasingly difficult to identify individual fibers as the number of fibers in a cable is increased. In principle, it is possible to increase the number of standardized colors. In practice, however, the need for unambiguous identification of fibers and possible fading or alteration of colors over time limits the number of colors available for marking fibers. There is accordingly a need for new ways to mark fibers to accommodate high fiber count cables.

### SUMMARY

An optical fiber having a coating that includes a photoreactive marking compound is described. The photoreactive marking compound has two states that differ in the intensity and/or wavelength of fluorescence. Exposure of the photoreactive marking compound to electromagnetic radiation induces a transformation of the photoreactive marking compound from one state to the other state. The difference in fluorescence between the two states provides a detectable contrast that can be used to mark the optical fiber. Selective application of the electromagnetic radiation to the fiber permits formation of sections along the optical fiber that differ in concentration of the two states of the photoreactive marking compound. The difference in concentration of the two states of the photoreactive marking compound in different sections produces a difference in fluorescence intensity along the length of the optical fiber. The variation in fluorescence intensity along the length of the optical fiber provides a way to identify the optical fiber. The variation in fluorescence intensity can be controlled by the time of exposure of the optical fiber to the electromagnetic radiation, the intensity of the electromagnetic radiation applied to the optical fiber, the length of the section(s) exposed to the electromagnetic radiation and/or the speed of the optical fiber as it moves through the electromagnetic radiation. A pattern of marks can be customized to different optical fibers to provide unique indicia that permit unambiguous identification of individual fibers. The coating may also include a pigment, where either or both of the pigment and photoreactive marking compound may function as a marker for identifying the optical fiber. Bundles of two or more optical fibers, each of which includes a coating containing a photoreactive marking compound, are also described. Cables and ribbons containing optical fibers or bundles of optical fibers with a coating containing the photoreactive marking compound are also disclosed.

The present description extends to:

A method of marking an optical fiber, comprising:

exposing a first section of the optical fiber to a marking radiation, the optical fiber comprising a glass fiber surrounded by a coating comprising a first layer, the first layer comprising a pigment and a photoreactive marking compound, the photoreactive marking compound having a first state and a second state, the second state differing in fluorescence from the first state when excited with a viewing radiation, the marking radiation transforming the photoreactive marking compound from the first state to the second state to form a mark on the first section of the optical fiber.

The present disclosure extends to:

An optical fiber comprising:

a glass fiber surrounded by a coating, the coating comprising:
a first layer, the first layer comprising a pigment and a photoreactive marking compound, the photoreactive marking compound having a first state and a second state, the second state differing in fluorescence from the first state when excited with a viewing radiation, the first layer including a first section and a second section, the first section having a first concentration of the first state of the photoreactive marking compound and the second section having a second concentration of the first state of the photoreactive marking compound, the first concentration differing from the second concentration.

The present disclosure extends to:

A method of marking an article, comprising:

exposing a first section of the article to a marking radiation, the article comprising a photoreactive marking compound, the photoreactive marking compound having a first state and a second state, the second state differing in fluorescence from the first state when excited with a viewing radiation, the marking radiation transforming the photoreactive marking compound from the first state to the second state to form a mark on the first section of the article.

Aspect 1 of the description is:

A method of marking an optical fiber, comprising:

exposing a first section of the optical fiber to a marking radiation, the optical fiber comprising a glass fiber surrounded by a coating comprising a first layer, the first layer comprising a pigment and a photoreactive marking compound, the photoreactive marking compound having a first state and a second state, the second state differing in fluorescence from the first state when excited with a viewing radiation, the marking radiation transforming the photoreactive marking compound from the first state to the second state to form a mark on the first section of the optical fiber.

Aspect 2 of the description is:

The method of Aspect 1, wherein the optical fiber is in motion when exposed to the marking radiation.

Aspect 3 of the description is:

The method of Aspect 1 or 2, wherein the marking radiation has a wavelength between 200 nm and 420 nm.

Aspect 4 of the description is:

The method of Aspect 1 or 2, wherein the marking radiation has a wavelength between 300 nm and 420 nm.

Aspect 5 of the description is:

The method of any of Aspects 1-4, wherein the marking radiation is provided by a source of electromagnetic radiation, the source of electromagnetic radiation comprising a laser or an LED (light emitting diode).

Aspect 6 of the description is:

The method of Aspect 5, wherein the source of electromagnetic radiation is in motion when the optical fiber is exposed to the marking radiation.

Aspect 7 of the description is:

The method of Aspect 5 or 6, wherein a power of the source of electromagnetic radiation is varied when the optical fiber is exposed to the marking radiation.

Aspect 8 of the description is:

The method of any of Aspects 1-7, wherein the coating comprises a second layer, the first layer surrounding the second layer.

Aspect 9 of the description is:

The method of any of Aspects 1-8, wherein the pigment comprises a color selected from the group consisting of white, blue, black, brown, red, green, aqua, yellow, rose, slate, or orange.

Aspect 10 of the description is:

The method of any of Aspects 1-9, wherein the pigment exhibits no visible fluorescence when excited by the viewing radiation.

Aspect 11 of the description is:

The method of any of Aspects 1-10, wherein the photoreactive marking compound comprises an optical brightener.

Aspect 12 of the description is:

The method of any of Aspects 1-11, wherein the first state fluoresces in the visible when excited by the viewing radiation.

Aspect 13 of the description is:

The method of any of Aspects 1-12, wherein the second state has no visible fluorescence when excited by the viewing radiation.

Aspect 14 of the description is:

The method of any of Aspects 1-13, wherein the viewing radiation comprises a UV (ultraviolet) wavelength.

Aspect 15 of the description is:

The method of any of Aspects 1-14, further comprising exposing a second section of the optical fiber to the marking radiation to form a second mark on the optical fiber, wherein the first mark and the second mark are separated by a first unmarked section of the optical fiber.

Aspect 16 of the description is:

The method of Aspect 15, further comprising exposing a third section of the optical fiber to the marking radiation to form a third mark on the optical fiber, wherein the third mark and the second mark are separated by a second unmarked section of the optical fiber.

Aspect 17 of the description is:

The method of any of Aspects 1-16, wherein the transforming the photoreactive marking compound from the first state to the second state comprises a structural rearrangement, a photochemical reaction or a decomposition of the photoreactive marking compound.

Aspect 18 of the description is:

The method of any of Aspects 1-17, further comprising identifying the mark, the identifying comprising detecting a first fluorescence from the first state of the photoreactive marking compound with the viewing radiation and a second fluorescence from a second state of the photoreactive marking compound with the viewing radiation.

Aspect 19 of the description is:

The method of Aspect 18, wherein the second fluorescence has a lower intensity than the first fluorescence.

Aspect 20 of the description is:

An optical fiber comprising:

a glass fiber surrounded by a coating, the coating comprising:
a first layer, the first layer comprising a pigment and a photoreactive marking compound, the photoreactive marking compound having a first state and a second state, the second state differing in fluorescence from the first state when excited with a viewing radiation, the first layer including a first section and a second section, the first section having a first concentration of the first state of the photoreactive marking compound and the second section having a second concentration of the first state of the photoreactive marking compound, the first concentration differing from the second concentration.

Aspect 21 of the description is:

The optical fiber of Aspect 20, wherein the first state fluoresces in the visible when excited by the viewing radiation.

Aspect 22 of the description is:

The optical fiber of Aspect 20 or 21, wherein the second state has no visible fluorescence when excited by the viewing radiation.

Aspect 23 of the description is:

The optical fiber of any of Aspects 20-22, wherein at least 70% of the photoreactive marking compound is in the second state in the first section and less than 20% of the photoreactive marking compound is in the second state in the second section.

Aspect 24 of the description is:

The optical fiber of any of Aspects 20-23, wherein the second section is consecutive with the first section.

Aspect 25 of the description is:

The optical fiber of any of Aspects 20-24, wherein the coating comprises a third section having a third concentration of the first state of the photoreactive marking compound.

Aspect 26 of the description is:

The optical fiber of Aspect 25, wherein the third concentration equals the first concentration.

Aspect 27 of the description is:

The optical fiber of Aspect 25 or 26, wherein the third section is consecutive with the second section and the second section is consecutive with the first section.

Aspect 28 of the description is:

A method of marking an article, comprising:

exposing a first section of the article to a marking radiation, the article comprising a photoreactive marking compound, the photoreactive marking compound having a first state and a second state, the second state differing in fluorescence from the first state when excited with a viewing radiation, the marking radiation transforming the photoreactive marking compound from the first state to the second state to form a mark on the first section of the article.

Aspect 29 of the description is:

The method of Aspect 28, wherein the marking radiation has a wavelength between 200 nm and 400 nm.

Aspect 30 of the description is:

The method of Aspect 28 or 29, wherein the photoreactive marking compound comprises an optical brightener.

Aspect 31 of the description is:

The method of any of Aspects 28-30, wherein the first state fluoresces in the visible when excited by the viewing radiation.

Aspect 32 of the description is:

The method of any of Aspects 28-31, wherein the second state has no visible fluorescence when excited by the viewing radiation.

Aspect 33 of the description is:

The method of any of Aspects 28-32, wherein the viewing radiation comprises a UV (ultraviolet) wavelength.

Aspect 34 of the description is:

The method of any of Aspects 28-33, wherein the transforming the photoreactive marking compound from the first state to the second state comprises a structural rearrangement, a photochemical reaction or a decomposition of the photoreactive marking compound.

Aspect 35 of the description is:

The method of any of Aspects 28-34, further comprising identifying the mark, the identifying comprising detecting a first fluorescence from the first state of the photoreactive marking compound with the viewing radiation and a second fluorescence from a second state of the photoreactive marking compound with the viewing radiation.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present description, and together with the specification serve to explain principles and operation of methods, products, and compositions embraced by the present description. Features shown in the drawing are illustrative of selected embodiments of the present description and are not necessarily depicted in proper scale.

### BRIEF DESCRIPTION OF THE DRAWINGS

While the specification concludes with claims particularly pointing out and distinctly claiming the subject matter of the written description, it is believed that the specification will be better understood from the following written description when taken in conjunction with the accompanying drawings, wherein:

FIG. 1 is a schematic cross-sectional view of a coated optical fiber.

FIG. 2 is a schematic view of a representative optical fiber ribbon.

FIG. 3 is a schematic view of a representative cable containing multiple optical fibers.

FIG. 4 shows absorption and emission spectra of a photoreactive marking compound.

FIG. 5 shows an optical fiber with marks.

FIG. 6 shows a portion of an optical fiber with marks.

FIG. 7 shows a portion of an optical fiber with a group of three marks.

FIG. 8 shows a portion of an optical fiber with two groups of marks.

FIG. 9 shows a schematic system for marking an optical fiber.

FIGS. 10A-C show portions of a white ink layer after exposure to marking radiation.

FIG. 11A shows a portion of a marked white ink layer when viewed under ambient lighting conditions.

FIG. 11B shows a portion of a marked white ink layer when viewed under UV light.

FIG. 12A shows a portion of a marked blue ink layer when viewed under ambient lighting conditions.

FIG. 12B shows a portion of a marked blue ink layer when viewed under UV light.

FIG. 13 shows fluorescence spectra of a photoreactive marking compound in white and blue ink layers before and after exposure to marking radiation.

FIG. 14A shows a portion of a marked black ink layer when viewed under UV light.

FIG. 14B shows a portion of a marked brown ink layer when viewed under UV light.

FIG. 15 shows a portion of a marked optical fiber when viewed under UV light

The embodiments set forth in the drawings are illustrative in nature and not intended to be limiting of the scope of the detailed description or claims. Whenever possible, the same reference numeral will be used throughout the drawings to refer to the same or like feature.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purpose of describing particular aspects only and is not intended to be limiting.

In this specification and in the claims that follow, reference will be made to a number of terms which shall be defined to have the following meanings:

Include,” “includes,” or like terms means encompassing but not limited to, that is, inclusive and not exclusive.

The term “about” references all terms in the range unless otherwise stated. For example, about 1, 2, or 3 is equivalent to about 1, about 2, or about 3, and further comprises from about 1-3, from about 1-2, and from about 2-3. Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described herein.

The indefinite article “a” or “an” and its corresponding definite article “the” as used herein means at least one, or one or more, unless specified otherwise.

As used herein, contact refers to direct contact or indirect contact. Direct contact refers to contact in the absence of an intervening material and indirect contact refers to contact through one or more intervening materials. Elements in direct contact touch each other. Elements in indirect contact do not touch each other, but do touch an intervening material or series of intervening materials, where the intervening material or at least one of the series of intervening materials touches the other. Elements in contact may be rigidly or non-rigidly joined. Contacting refers to placing two elements in direct or indirect contact. Elements in direct (indirect) contact may be said to directly (indirectly) contact each other.

The term “wt %” means weight percent.

The term “UV” means ultraviolet and refers to electromagnetic radiation having a wavelength in the range from 200 nm to 400 nm. The term “visible” refers to electromagnetic radiation having a wavelength in the range from 400 nm to 700 nm. The term “visible fluorescence” refers to fluorescence at one or more wavelengths in the range from 400 nm to 700 nm. The term “infrared” refers to electromagnetic radiation having a wavelength in the range from 700 nm to 2000 nm.

The term “blue” refers to the portion of the electromagnetic spectrum between 400 nm and 450 nm.

The term “optical brightener” refers to a compound exhibiting blue fluorescence when excited with UV radiation.

The term “consecutive” when used in reference to sections of an optical fiber means immediately in succession along the length of an optical fiber. Two sections of an optical fiber are said to be consecutive, or consecutive to each other, when ends of each of the section are in direct contact along the length of the optical fiber.

As used herein, the term “curable”, when used in reference to a component of a coating composition, is intended to mean that the component, when exposed to a suitable source of curing energy, includes one or more curable functional groups capable of forming covalent bonds that participate in linking the component to itself or to other components of the coating composition to form a polymeric coating material (i.e., the cured product of the coating composition). The curing process may be induced by energy. Forms of energy include radiation or thermal energy. A radiation-curable component is a component that can be induced to undergo a curing reaction when exposed to electromagnetic radiation of a suitable wavelength at a suitable intensity for a sufficient period of time. The radiation curing reaction may occur in the presence of a photoinitiator. A radiation-curable component may also optionally be thermally curable.

A curable component includes one or more curable functional groups. A curable component with only one curable functional group is referred to herein as a monofunctional curable component. A curable component having two or more curable functional groups is referred to herein as a multifunctional curable component or a polyfunctional curable component. Multifunctional curable components include two or more functional groups capable of forming covalent bonds during the curing process and may introduce crosslinks into the polymeric network formed during the curing process. Multifunctional curable components may also be referred to herein as “crosslinkers” or “curable crosslinkers”. Examples of functional groups that participate in covalent bond formation during the curing process are identified hereinafter.

As used herein, the terms “non-curable” and “non-radiation curable” refer to a compound or component of a coating composition that lacks functional groups capable of forming covalent bonds when exposed to the source of curing energy (radiation, thermal) during the curing process. The term “non-reactive” refers to a compound or component of a coating composition that does not react with other components of the coating composition under the conditions used in curing the coating composition. Non-reactive compounds or components are also non-curable.

As used herein, fluorescence includes luminescence, phosphorescence, and other processes in which a state of a photoreactive marking compound absorbs light at one wavelength and emits light at one or more different wavelengths. When comparing the fluorescence of two states of a photoreactive marking compound, it is understood that the comparison is made with respect to common excitation conditions for the two states.

The term “photoreactive marking compound” refers to a compound having two (or more) states that differ in fluorescence. The difference in fluorescence is a difference in intensity, band shape, bandwidth, and/or wavelength (or wavelength range) of fluorescence of the two states under common excitation conditions. Absorption of electromagnetic radiation of suitable wavelength and intensity by the photoreactive marking compound induces a transformation of the photoreactive marking compound from one of the two states that differ in fluorescence to the other of the two states that differ in fluorescence. The transformation includes a structural rearrangement and/or a photochemical reaction or decomposition of the photoreactive marking compound.

The term “mark” or “marked section” refers to a section along the length of an optical fiber that has been exposed to electromagnetic radiation with a wavelength and intensity sufficient to induce the transformation of the photoreactive marking compound from one of the two states that differ in fluorescence to the other of the two states that differ in fluorescence. Electromagnetic radiation with a wavelength and intensity sufficient to form a mark is referred to as “marking radiation”. The wavelength of the marking radiation is referred to as the “marking wavelength”. The optical fiber includes one or a plurality of marked sections. The term “unmarked” or “unmarked section” refers to a section along the length of an optical fiber that has not been intentionally exposed to marking radiation. The optical fiber includes one or a plurality of unmarked sections. Electromagnetic radiation that detects a mark is referred to as “viewing radiation”. Viewing radiation reveals a contrast in the fluorescence of marked and unmarked sections of the optical fiber. Preferably, the fluorescence of the unmarked sections has a higher intensity than the fluorescence of the marked sections upon exposure to the viewing radiation. The wavelength of the viewing radiation may be the same as or different from the wavelength of the marking radiation. Preferably, the marking radiation and viewing radiation are at a wavelength within an absorption band of the initial state of the photoreactive marking compound that produces the fluorescence of the unmarked section of the optical fiber. Unlike the marking radiation, however, the intensity of the viewing radiation is insufficient to induce a transformation of the state of the photoreactive marking compound. That is, the state of the photoreactive marking compound is stable when exposed to viewing radiation. The viewing radiation is intended to reveal a contrast in the fluorescence of the transformed state of the photoreactive marking compound in the marked sections and the non-transformed state of the photoreactive marking compound in the unmarked sections.

The state of the photoreactive marking compound before exposure to marking radiation is referred to as the “first state” or “initial state”. The state of the photoreactive marking compound after exposure to marking radiation is referred to as the “second state” or “transformed state”. Marking refers to the process of converting the photoreactive marking compound from the initial state to the transformed state. Transformation of the photoreactive marking compound in a marked section is partial or complete. For example, the marking radiation may transform 5% or more, or 10% or more, or 25% or more, or 50% or more, or 75% or more of the concentration of the photoreactive marking compound from the initial state to the transformed state in a marked section of the optical fiber. The concentration of the transformed state of the photoreactive marking compound in different marked sections may be the same or different. The concentration of the transformed state of the photoreactive marking compound is greater in a marked section of the optical fiber than in an unmarked section of the optical fiber. The concentration of the transformed state of the photoreactive marking compound in different unmarked sections of the optical fiber is approximately the same and is preferably less than 5% of the concentration of the photoreactive marking compound in the unmarked section.

Reference will now be made in detail to illustrative embodiments of the present description.

The present description provides marked optical fibers, methods for marking optical fibers, cables containing marked optical fibers, and coatings and coating compositions for marking optical fibers. Marking of optical fibers is accomplished by incorporating a photoreactive marking compound in the coating of an optical fiber and selectively transforming the photoreactive marking compound from an initial state to a transformed state in one or more sections along the length of the optical fiber to form one or more marks. The one or more marks function as indicia for identifying the optical fiber.

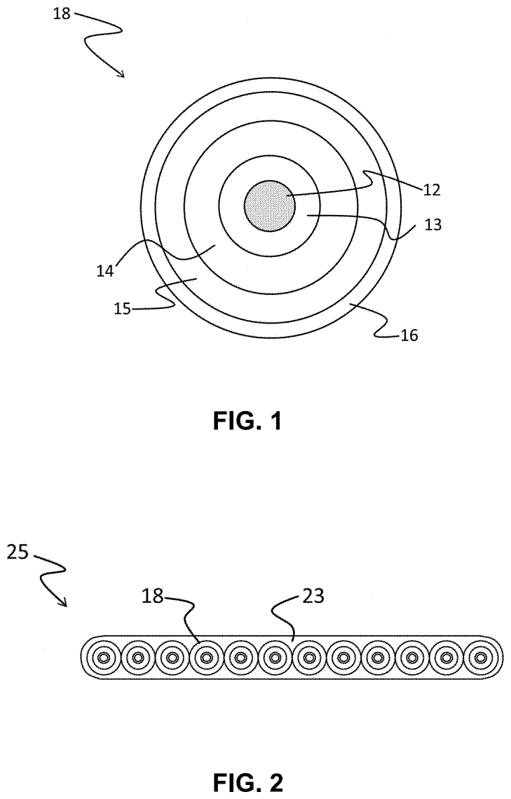

An example of an optical fiber is shown in schematic cross-sectional view in FIG. 1. An optical fiber includes a glass fiber surrounded by a coating. The glass fiber includes one or more concentric glass regions and functions as a waveguide. The coating includes one or more concentric coatings. Optical fiber 18 includes a glass fiber with glass core 12 and glass cladding 13. Optical fiber 18 includes a coating with primary layer 14, secondary layer 15, and ink layer 16. The primary layer is a soft (low modulus) coating surrounding the glass portion of the fiber and the secondary layer is a hard (high modulus) coating surrounding the primary layer. The secondary layer is mechanically rigid and allows the fiber to be handled during processing without damage to the fiber, while the primary layer dissipates external forces and minimizes attenuation of the guided optical signal caused by microbending. Although depicted as a distinct layer in FIG. 1, in certain embodiments, the ink layer 16 may also function as a secondary layer and a separate unpigmented secondary layer may be absent. An ink layer that functions as a secondary layer may be referred to herein as a “pigmented secondary layer”. The primary layer 14, secondary layer 15, and ink layer 16 are polymers formed as cured products of radiation-curable coating compositions. The photoreactive marking compound is preferably in the outermost coating (e.g. ink layer or pigmented secondary layer).

FIG. 2 illustrates an optical fiber ribbon 25. The ribbon 25 includes a plurality of optical fibers 18 and a matrix 23 encapsulating the plurality of optical fibers. Optical fibers 18 may include a core glass region, a cladding glass region, a primary layer, a secondary layer, and an ink layer. Alternatively, optical fibers 18 may include a core glass region, a cladding glass region, a primary layer, and a pigmented secondary layer. The optical fibers 18 are aligned relative to one another in a substantially planar and parallel relationship. The optical fibers in fiber optic ribbons may be encapsulated by the matrix 23 in any known configuration (e.g., edge-bonded ribbon, thin-encapsulated ribbon, thick-encapsulated ribbon, or multi-layer ribbon) by conventional methods of making fiber optic ribbons. In FIG. 2, the fiber optic ribbon 25 contains twelve (12) optical fibers 18; however, it should be apparent to those skilled in the art that any number of optical fibers 18 (e.g., two or more) may be employed to form fiber optic ribbon 25. The matrix 23 has a high modulus and is compositionally similar to a secondary layer.

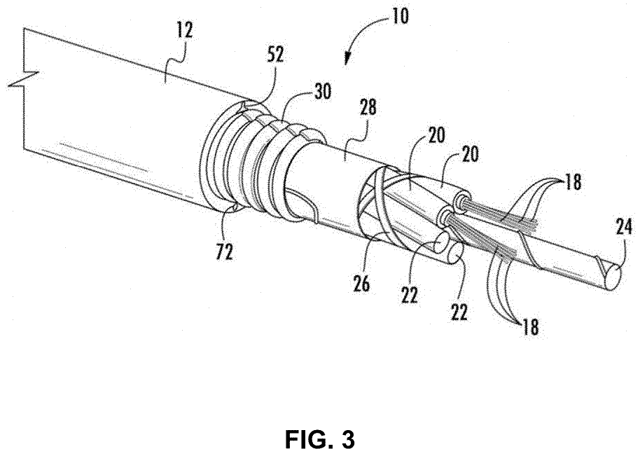

FIG. 3 depicts a representative optical communication cable. Cable 10 includes jacket 12 with buffer tubes 20 and filler rods 22 wrapped around support rod 24. Buffer tubes 20 enclose a plurality of optical fibers 18 and are wrapped by helical binders 26. Cable 10 also includes moisture barrier 28, protective tube 30, split resistant feature 52, and access feature 72. Further discussion of the features of cable 10 can be found in U.S. Pat. No. 9,140,867. Numerous other cable designs are known in the art, including designs in which ribbons of the type shown in FIG. 2 are bundled, and can be constructed with the marked fibers disclosed herein.

The ink layer is formed from an ink layer composition. Pigmented secondary layers can also be formed from the ink layer compositions described herein. In embodiments, the ink layer is the cured product of an ink layer composition. The ink layer composition is preferably a radiation-curable liquid composition. The radiation-curable ink layer composition may include one or more radiation-curable monomers, one or more radiation-curable oligomers, one or more photoinitiators, one or more pigments, and one or more photoreactive marking compounds. The radiation-curable ink layer composition may also optionally include additives such as anti-oxidants, catalyst(s), a carrier or surfactant, a slip agent, and a stabilizer.

The one or more radiation-curable monomers may be present in the ink layer composition in an amount in the range from 50 wt %-97 wt %, or in the range from 60 wt %-95 wt %, or in the range from 70 wt %-90 wt %. The one or more radiation-curable oligomers may be present in the ink layer composition in an amount in the range from 0 wt %-20 wt %, or in the range from 0 wt %-10 wt %, or in the range from 0 wt %-5 wt %. The one or more photoinitiators may be present in the ink layer composition in an amount in the range from 0.5 wt %-10 wt %, or in the range from 1 wt %-8 wt %, or in the range from 2 wt %-6 wt %. The one or more pigments may be present in the ink layer composition in an amount in the range from 1 wt %-20 wt %, or in the range from 2 wt %-15 wt %, or in the range from 3 wt %-12 wt %, or in the range from 4 wt % to 10 wt %. The one or more photoreactive marking compounds may be present in the ink layer composition in an amount in the range from 0.01 wt %-10 wt %, or in the range from 0.05 wt %-5 wt %, or in the range from 0.10 wt %-2 wt %, or in the range from 0.10 wt %-1 wt %. The ink layer composition may also include up to 25 wt % of dispersant to promote a more uniform, less aggregated distribution of the pigment.

Due to the low volatility of the components in the ink layer composition, the composition of the cured product of the ink layer composition will closely match the composition of the ink layer composition. Reactive functional groups will transform to form reaction products, but the transformations are expected to have little effect on the proportion of reactive components (or residues thereof) in the cured product.

Accordingly, the cured product of the ink layer composition may include reacted residues from one or more radiation-curable monomers in an amount in the range from 50 wt %-97 wt %, or in the range from 60 wt %-95 wt %, or in the range from 70 wt %-90 wt %. Reacted residues from the one or more radiation-curable oligomers may be present in the cured product of the ink layer composition in an amount in the range from 0 wt %-20 wt %, or in the range from 0 wt %-10 wt %, or in the range from 0 wt %-5 wt %. The reacted residue of one or more photoinitiators may be present in the cured product of the ink layer composition in an amount in the range from 0.5 wt %-10 wt %, or in the range from 1 wt %-8 wt %, or in the range from 2 wt %-6 wt %. The one or more pigments may be present in the cured product of the ink layer composition in an amount in the range from 1 wt %-20 wt %, or in the range from 2 wt %-15 wt %, or in the range from 3 wt %-12 wt %, or in the range from 4 wt %-10 wt %. The one or more photoreactive marking compounds may be present in the cured product of the ink layer composition in an amount in the range from 0.01 wt %-10 wt %, or in the range from 0.05 wt %-5 wt %, or in the range from 0.10 wt %-2 wt %. The cured product of the ink layer composition may also include up to 25 wt % of dispersant.

Preferably, the monomeric component of the ink layer composition includes one or more ethylenically unsaturated monomers. Ethylenically unsaturated monomers include ethylenically unsaturated groups that are radiation curable. The radiation-curable ethylenically unsaturated groups may be acrylate or methacrylate groups. As used herein, the term “(meth)acrylate” refers to acrylate, methacrylate, or a combination of acrylate and methacrylate. The ethylenically unsaturated monomers may be multifunctional (containing two or more radiation-curable functional groups) monofunctional (containing a single radiation-curable functional group). Therefore, the ethylenically unsaturated monomer can be a multifunctional monomer, a monofunctional monomer, or mixtures thereof. Suitable radiation-curable functional groups for ethylenically unsaturated monomers used in accordance with the present invention include, without limitation, (meth)acrylates, acrylamides, N-vinyl amides, styrenes, vinyl ethers, vinyl esters, acid esters, and combinations thereof.

Suitable multifunctional ethylenically unsaturated monomers for the ink layer composition include, without limitation, alkoxylated bisphenol A diacrylates such as ethoxylated bisphenol A diacrylate with a degree of ethoxylation being 2 or greater, preferably ranging from 2 to about 30 (e.g. SR349 and SR601 available from Sartomer Company, Inc. (West Chester, Pa.), Miramer M240 and Miramer M244 (available from Miwon), and Photomer 4025 and Photomer 4028, available from IGM Resins Inc. (Charlotte, N.C.)), and propoxylated bisphenol A diacrylate with a degree of propoxylation being 2 or greater, preferably ranging from 2 to about 30; methylolpropane polyacrylates with and without alkoxylation such as ethoxylated trimethylolpropane triacrylate with a degree of ethoxylation being 3 or greater, preferably ranging from 3 to about 30 (e.g., Photomer 4149, (IGM Resins Inc.) and SR499 (Sartomer), propoxylated-trimethylolpropane triacrylate with a degree of propoxylation being 3 or greater, preferably ranging from 3 to 30 (e.g., Photomer 4072 (IGM Resins, Inc.) and SR492 (Sartomer)), and ditrimethylolpropane tetraacrylate (e.g., Photomer 4355 (IGM Resins, Inc.)); alkoxylated glyceryl triacrylates such as propoxylated glyceryl triacrylate with a degree of propoxylation being 3 or greater (e.g., Photomer 4096 (IGM Resins, Inc.) and SR9020 (Sartomer)); erythritol polyacrylates with and without alkoxylation, such as pentaerythritol tetraacrylate (e.g., SR295 (Sartomer), ethoxylated pentaerythritol tetraacrylate (e.g., SR494 (Sartomer), and dipentaerythritol pentaacrylate (e.g., Photomer 4399 (IGM Resins, Inc.) and SR399 (Sartomer); isocyanurate polyacrylates formed by reacting an appropriate functional isocyanurate with an acrylic acid or acryloyl chloride, such as tris-(2-hydroxyethyl) isocyanurate triacrylate (e.g., SR368 (Sartomer)) and tris-(2-hydroxyethyl) isocyanurate diacrylate; alcohol polyacrylates with and without alkoxylation such as tricyclodecane dimethanol diacrylate (e.g., CD406, (Sartomer)) and ethoxylated polyethylene glycol diacrylate with a degree of ethoxylation being 2 or greater, preferably ranging from about 2 to 30; epoxy acrylates formed by adding acrylate to bisphenol A diglycidylether (4 or more oxyethylene groups) and the like (e.g., Photomer 3016 (IGM Resins, Inc.); and single and multi-ring cyclic aromatic or non-aromatic polyacrylates such as dicyclopentadiene diacrylate and dicyclopentane diacrylate.

Exemplary monofunctional ethylenically unsaturated monomers include, without limitation, hydroxyalkyl acrylates such as 2-hydroxyethyl-acrylate, 2-hydroxypropyl-acrylate, and 2-hydroxybutyl-acrylate; long- and short-chain alkyl acrylates such as methyl acrylate, ethyl acrylate, propyl acrylate, isopropyl acrylate, butyl acrylate, amyl acrylate, isobutyl acrylate, t-butyl acrylate, pentyl acrylate, isoamyl acrylate, hexyl acrylate, heptyl acrylate, octyl acrylate, isooctyl acrylate, 2-ethylhexyl acrylate, nonyl acrylate, decyl acrylate, isodecyl acrylate, undecyl acrylate, dodecyl acrylate, lauryl acrylate, octadecyl acrylate, and stearyl acrylate; aminoalkyl acrylates such as dimethylaminoethyl acrylate, diethylaminoethyl acrylate, and 7-amino-3,7-dimethyloctyl acrylate; alkoxyalkyl acrylates such as butoxyethyl acrylate, phenoxyethyl acrylate (e.g., SR339 (Sartomer)), and ethoxyethoxyethyl acrylate; single and multi-ring cyclic aromatic or non-aromatic acrylates such as cyclohexyl acrylate, benzyl acrylate, dicyclopentadiene acrylate, dicyclopentanyl acrylate, tricyclodecanyl acrylate, bomyl acrylate, isobornyl acrylate (e.g., SR423 (Sartomer)), tetrahydrofiurfuryl acrylate (e.g., SR285 (Sartomer)), caprolactone acrylate (e.g., SR495, (Sartomer)), and acryloylmorpholine; alcohol-based acrylates such as polyethylene glycol monoacrylate, polypropylene glycol monoacrylate, methoxyethylene glycol acrylate, methoxypolypropylene glycol acrylate, methoxypolyethylene glycol acrylate, ethoxydiethylene glycol acrylate, and various alkoxylated alkylphenol acrylates such as ethoxylated(4)nonylphenol acrylate (e.g., Photomer 4003 (IGM Resins, Inc.)); acrylamides such as diacetone acrylamide, isobutoxymethyl acrylamide, N,N′-dimethyl-aminopropyl acrylamide, N,N-dimethyl acrylamide, N,N diethyl acrylamide, and t-octyl acrylamide; vinylic compounds such as N-vinylpyrrolidone and N-vinylcaprolactam; and acid esters such as maleic acid ester and fumaric acid ester. With respect to the long and short chain alkyl acrylates listed above, a short chain alkyl acrylate is an alkyl group with 6 or less carbons and a long chain alkyl acrylate is alkyl group with 7 or more carbons.

Most suitable monomers are commercially available (suppliers for selected compounds noted above) or readily synthesized using reaction schemes known in the art. Many monomers can be formed, for examples, from reactions between an appropriate (di)alcohol or (di)amine with (meth)acrylic acid or (meth)acryloyl chloride.

The ink layer composition may exclude radiation-curable oligomers or the ink layer composition may include an oligomeric component with one or more radiation-curable oligomers. The one or more oligomers may include one or more monofunctional oligomers, one or more multifunctional oligomers, or a combination thereof. Preferable oligomer(s) includes ethylenically unsaturated oligomer(s), such as aliphatic and aromatic urethane (meth)acrylate oligomers, urea (meth)acrylate oligomers, polyester and polyether (meth)acrylate oligomers, acrylated acrylic oligomers, polybutadiene (meth)acrylate oligomers, polycarbonate (meth)acrylate oligomers, and melamine (meth)acrylate oligomers.

The oligomeric component of the ink layer composition may include a difunctional oligomer. A difunctional oligomer may have a structure according to formula (I) below:

F₁—R₁-[diisocyanate-R₂-diisocyanate]ₘ-R₁—F₁ (I)

where F₁ may independently be a reactive functional group such as acrylate, methacrylate, acrylamide, N-vinyl amide, styrene, vinyl ether, vinyl ester, or other functional group known in the art; R₁ may include, independently, —C₂₋₁₂O—, —(C₂₋₄—O)ₙ—, —C₂₋₁₂O—(C₂₋₄—O)ₙ—C₂₋₁₂O—(CO—C₂₋₅O)ₙ—, or —C₂₋₁₂O—(CO—C₂₋₅NH)ₙ— where n is a whole number from 1 to 30, including, for example, from 1 to 10; R₂ may be a polyether, polyester, polycarbonate, polyamide, polyurethane, polyurea, or combination thereof; and m is a whole number from 1 to 10, including, for example, from 1 to 5. In the structure of formula (I), the diisocyanate moiety may be the residue formed from the reaction of a diisocyanate with R₂ and/or R₁. The term “independently” is used herein to indicate that each F₁ may differ from another F₁ and the same is true for each R₁.

The oligomer component of the curable ink layer composition may include a polyfunctional oligomer. The polyfunctional oligomer may have a structure according to formula (II), formula (III), or formula (IV) set forth below:

multiisocyanate-(F₂—R₁—F₂)ₓ (II)

polyol-[(diisocyanate-R₂-diisocyanate)ₘ-R₁—F₂]ₓ (III)

multiisocyanate-(R₁—F₂)ₓ (IV)

where F₂ may independently represent from 1 to 3 functional groups such as acrylate, methacrylate, acrylamide, N-vinyl amide, styrene, vinyl ether, vinyl ester, or other functional groups known in the art; R₁ can include —C₂₋₁₂O—, —(C₂₋₄O)ₙ—, —C₂₋₁₂O—(C₂₋₄O)ₙ—, —C₂₋₁₂O—(CO—C₂₋₅O)ₙ, or —C₂₋₁₂O(CO—C₂₋₅NH)ₙ where n is a whole number from 1 to 10, including, for example, from 1 to 5; R₂ may be polyether, polyester, polycarbonate, polyamide, polyurethane, polyurea or combinations thereof; x is a whole number from 1 to 10, including, for example, from 2 to 5; and m is a whole number from 1 to 10, including, for example, from 1 to 5. In the structure of formula (II), the multiisocyanate group may be the residue formed from reaction of a multiisocyanate with R₂. Similarly, the diisocyanate group in the structure of formula (III) may be the reaction product formed following bonding of a diisocyanate to R₂ and/or R₁.

Urethane oligomers may be prepared by reacting an aliphatic or aromatic diisocyanate with a dihydric polyether or polyester, most typically a polyoxyalkylene glycol such as a polyethylene glycol. Moisture-resistant oligomers may be synthesized in an analogous manner, except that polar polyethers or polyester glycols are avoided in favor of predominantly saturated and predominantly nonpolar aliphatic diols. These diols may include alkane or alkylene diols of from about 2-250 carbon atoms that may be substantially free of ether or ester groups.

Polyurea elements may be incorporated in oligomers prepared by these methods, for example, by substituting diamines or polyamines for diols or polyols in the course of synthesis. The presence of minor proportions of polyureas in the secondary layer composition is not considered detrimental to ink layer performance, provided that the diamines or polyamines employed in the synthesis are sufficiently non-polar and saturated as to avoid compromising the moisture resistance of the system.

The ink layer composition includes a polymerization initiator. The polymerization initiator is a reagent that is suitable to cause polymerization (i.e., curing) of the composition. Curing of the composition induces a transition of the ink layer composition from a viscous liquid state to a solid state. Polymerization initiators suitable for use in the ink layer composition include thermal initiators, chemical initiators, electron beam initiators, and photoinitiators. Photoinitiators are the preferred polymerization initiators. For most (meth)acrylate-based coating formulations, conventional photoinitiators, such as the known ketonic photoinitiators and/or phosphine oxide photoinitiators, are preferred. Photoinitiators are reactive components and undergo reaction, rearrangement, or decomposition to provide chemical species (e.g. free radicals) capable of initiating a photoreaction with a curable component of the ink layer composition. Activation of a photoinitiator to provide reactive species for photopolymerization of radiation-curable components of the ink layer composition is accomplished by exposing the photoinitiator to a suitable wavelength of radiation. In preferred embodiments, the photoinitiator is activated by UV radiation and the ink layer composition is a UV-curable composition.

Suitable photoinitiators include, without limitation, 1-hydroxycyclohexyl-phenyl ketone (e.g. Irgacure 184 available from BASF), (2,6-dimethoxybenzoyl)-2,4,4-trimethylpentyl phosphine oxide; commercial blends of (2,6-dimethoxybenzoyl)-2,4,4-trimethylpentyl phosphine oxide with Irgacure 184 (e.g. Irgacure 1800, 1850, 1870, and 1700 available from BASF), 2,2-dimethoxyl-2-phenyl acetophenone (e.g. Irgacure 651, available from BASF), bis(2,4,6-trimethyl benzoyl)phenyl-phosphine oxide (e.g. Irgacure 819, available from BASF), (2,4,6-trimethylbenzoyl)diphenyl phosphine oxide (e.g. Lucirin TPO available from BASF), ethoxy(2,4,6-trimethylbenzoyl)phenyl phosphine oxide (e.g. Lucirin TPO-L from BASF), and combinations thereof.

Pigments of various colors are known in the art and are available from commercial sources. The pigments used herein were energy curable dispersions of colored particles obtained from Penn Color (Doylestown, Pa.). The energy curable dispersions are curable upon excitation of light of a suitable wavelength. The excitation wavelength is preferably a UV wavelength. Specific formulations for the energy curable dispersions are proprietary to the manufacturer, but the dispersions generally included a suspension of colored particles in a curable liquid suspension medium. Particles diameters are preferably kept at 1 micron or less to promote uniformity of dispersion and minimize aggregation. The curable liquid suspension medium included one or more proprietary acrylate and/or acrylate derivative compounds, and a proprietary curing agent. Other compounds in the curable liquid suspension medium may include propoxylated neopentyl glycol diacrylate, vinyl caprolactam, and/or butyl benzyl phthalate. Specific product numbers for different colors will be noted in the Examples described hereinbelow. The pigments preferably exhibit no visible fluorescence when excited by radiation that produces fluorescence when absorbed by the photoreactive marking compound. For example, the pigments preferably have no visible fluorescence when excited by the viewing radiation.

The ink layer composition includes one or more photoreactive marking compounds. Examples of photoreactive marking compounds include photoreactive marking compounds. Representative photoreactive marking compounds include optical brighteners, derivatives of benzoxazole compounds (e.g. Hostalux® KCB (from Clariant of Muttenz, Switzerland), or Hostalux® KCU (from Clariant)); 2,2′-(2,5-thiophenediyl) bis[5-tert-butylbenzoxazole](e.g. Benetex® OB from Mayzo, Inc. (Suwanee, Ga.)); 4,4′-bis(2-benzoxazolyl) stilbene (e.g. Eastobrite® OB-1 from Eastman Chemical (Kingsport, Tenn.)); derivatives of 4,4′-diminostilbene-2-2′disulfonic acid, 4-methyl-7-diethylaminocoumarin, Uvitex® OB (2,5-thiophenediylbis(5-tert-butyl-1,3-benzoxazole) (BASF)); Blankophor KLA (Bayer); bisbenzoxazole compounds; phenylcoumarin compounds; and bis(styryl)biphenyl compounds.

Photoreactive marking compounds include compounds that absorb light at wavelengths less than 450 nm, or wavelengths less than 425 nm, or wavelengths less than 400 nm, or wavelengths less than 375 nm, or wavelengths less than 350 nm and that emit light at wavelengths greater than the wavelength of absorbed light. For any of the absorbed wavelengths of light noted above, the emitted light may occur at a wavelength less than 650 nm, or less than 600 nm, or less than 550 nm, or less than 500 nm. In one embodiment, a photoreactive compounds fluoresces in the visible when excited by UV radiation. The emitted light constitutes fluorescence and typically occurs over a range of wavelengths, referred to as a fluorescence band that has an intensity profile (intensity as a function of wavelength) characteristic of the photoreactive marking compound.

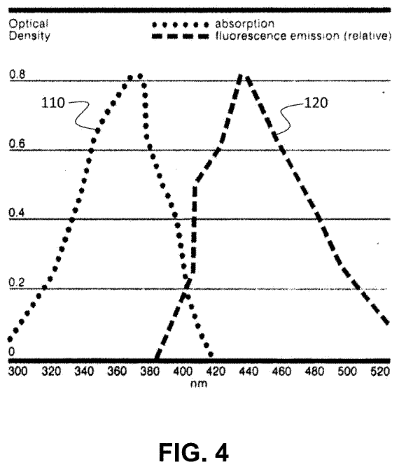

The fluorescence is produced by exciting an absorption band of the photoreactive marking compound. FIG. 4 shows an example of the absorption and fluorescence spectra of Benetex® OB, a representative photoreactive marking compound, at a concentration of 7 mg/L in ethanol solution. The absorption spectrum includes absorption band 110 and the fluorescence spectrum includes fluorescence band 120. Excitation of Benetex® OB at a wavelength in absorption band 110 produces fluorescence band 120. Under normal excitation intensities, the initial state of Benetex® OB is stable and the fluorescence persists at constant intensity under multiple cycles of excitation and emission under given excitation conditions. A similar observation holds for other photoreactive marking compounds within the scope of the present disclosure. For purposes of the present disclosure, however, it has been recognized that when the excitation intensity is above a critical threshold, the initial state of the photoreactive marking compound is unstable and the photoreactive marking compound transforms to a transformed state having no fluorescence or fluorescence that differs in wavelength, line shape, and/or intensity from the fluorescence of the initial state. The difference in fluorescence between the initial and transformed states of the photoreactive marking compound is exploited herein to provide a mechanism for marking and identifying optical fibers (see examples below).

When configured as a standalone layer, the thickness of the ink layer after curing may be in the range from 0.5 μm-20 μm, or in the range from 1 μm-10 μm, or in the range from 2 μm-8 μm. When configured as a pigmented secondary layer, the thickness of the ink layer after curing may be in the range from 10 μm-50 μm, or in the range from 15 μm-45 μm, or in the range from 20 μm-40 μm.

The photoreactive marking compound can be included in ink layers or pigmented secondary layers having pigments of any color, including ink layers lacking a pigment. The fluorescence variation of the photoreactive marking compound provides a marker useful for identifying optical fibers independently or in concert with the color of the pigment. In preferred embodiments, the presence of a photoreactive marking compound in the ink layer does not alter the color of the ink layer as viewed by the naked eye under room lighting conditions and the color of the ink layer, as perceived by the naked eye under room lighting conditions, is determined by the color, type, and concentration of pigment in the ink layer. When excited by light of an appropriate wavelength (e.g. UV wavelength), however, the photoreactive marking compound emits light that can be detected (by the naked eye or with a light-detecting instrumentation) and used to identify a fiber.

The present description encompasses an optical fiber with an ink layer or pigmented secondary layer that includes a photoreactive marking compound. The concentration of photoreactive marking compound in the ink layer (or pigmented secondary layer) composition used to form the ink layer (or pigmented secondary layer) of an optical fiber may be greater than 0.01 pph, or greater than 0.05 pph, or greater than 0.1 pph, or greater than 0.2 pph, or greater than 0.4 pph, or greater than 0.5 pph, or greater than 0.6 pph, or greater than 0.7 pph, or greater than 0.8 pph, or in the range from 0.01 pph-10 pph, or in the range from 0.05 pph-8 pph, or in the range from 0.1 pph-6 pph, or in the range from 0.2 pph-4 pph, or in the range from 0.3 pph-3 pph, or in the range from 0.4 pph-2 pph. The ink layer of the optical fiber may include two or more photoreactive marking compounds, where the concentration of each photoreactive marking compound in the ink layer composition used to form the ink layer or the combined concentration of all photoreactive marking compounds in the ink layer composition used to form the ink layer are within the ranges stated herein. Each of two or more photoreactive marking compounds may be supplied in a separate ink layer composition or two or more photoreactive marking compounds may be combined and included in a single ink layer composition.

The present description encompasses bundles of optical fibers that include ink layers or pigmented secondary layers with different photoreactive marking compounds or different concentrations of the same photoreactive marking compound. Bundles of optical fibers are fiber assemblies that include a combination of two or more optical fibers. Fiber bundles may be incorporated in cables.

By varying the concentration of photoreactive marking compound in the ink layer or pigmented secondary layer, the intensity of fluorescence from a fluorescent state can be varied. Either or both of the wavelength(s) and intensity of light emitted by the photoreactive marking compound(s), or the relative concentration of fluorescent and non-fluorescent states (or different fluorescent states), may be used to identify and distinguish different optical fibers in a bundle, ribbon, or cable. The two or more optical fibers may include fibers colored by the same or different pigment. A combination of optical fibers, for example, may contain two fibers with blue pigment, where each of the fibers includes an ink layer with a photoreactive marking compound and where the photoreactive marking compounds are the same or different compound, or the same compound in different concentrations, or the same compound in different states that differ in fluorescence. The combination of optical fibers may include one or more fibers with ink layers containing a photoreactive marking compound and one or more fibers with ink layers lacking a photoreactive marking compound. Fibers with ink layers lacking a photoreactive marking compound are distinguishable because they lack the fluorescence observed from fibers with ink layers containing a photoreactive marking compound. Absence of the fluorescence signal serves as a marker of fibers with ink layers lacking a photoreactive marking compound.

In addition to one or more optical fibers with ink layers having photoreactive marking compound(s) at concentrations noted above, the bundle of optical fibers may also include one or more fibers with an ink layer that lacks a photoreactive marking compound and/or one or more fibers with an ink layer that includes a photoreactive marking compound at a concentration greater than 0 pph and less than 0.5 pph, or at a concentration greater than 0 pph and less than 0.4 pph, or at a concentration greater than 0 pph and less than 0.3 pph, or at a concentration greater than 0 pph and less than 0.2 pph, or at a concentration greater than 0 pph and less than 0.1 pph.

In addition to the base components (one or more radiation-curable monomers, one or more radiation-curable oligomers, one or more photoinitiators, one or more pigments, and one or more photoreactive marking compounds), the ink layer composition may also include one or more additives. The one or more additives are optional and may include an adhesion promoter, an antioxidant, a catalyst, a carrier or surfactant, a tackifier, a stabilizer, or a slip agent. Some additives (e.g., catalysts, reactive surfactants) may operate to control the polymerization process and may thereby affect the physical properties (e.g., modulus, glass transition temperature) of the cured product formed from the coating composition. Other additives may influence the integrity of the cured product of the coating composition (e.g., protection against UV-induced curing or oxidative degradation).

The concentration of additives and photoreactive marking compounds is expressed in units of “pph” (parts per hundred). The unit “pph” refers to an amount of an additive relative to a base composition that includes all monomers, oligomers, pigments, and photoinitiators. An additive or photoreactive marking compound concentration of 1.0 pph corresponds to 1 g of the additive or photoreactive marking compound per 100 g combined of monomer(s), oligomer(s), and pigment(s), and photoinitiator(s).

An adhesion promoter enhances the adhesion of the ink layer to the underlying secondary layer or primary layer. Examples of a suitable adhesion promoter include, without limitation, organofunctional silanes, titanates, zirconates, and mixtures thereof. One preferred class are the poly(alkoxy)silanes. Suitable alternative adhesion promoters include, without limitation, bis(trimethoxysilylethyl)benzene, 3-mercaptopropyltrimethoxy-silane (3-MPTMS, available from United Chemical Technologies, Bristol, Pa.; also available from Gelest, Morrisville, Pa.), 3-acryloxypropyltrimethoxysilane (available from Gelest), and 3-methacryloxypropyltrimethoxysilane (available from Gelest), and bis(trimethoxysilylethyl)benzene (available from Gelest). Other suitable adhesion promoters are described in U.S. Pat. Nos. 4,921,880 and 5,188,864 to Lee et al., each of which is hereby incorporated by reference. The adhesion promoter, if present, is used in an amount between about 0.1 pph to about 10 pph, more preferably about 0.25 pph to about 3 pph.

Antioxidants provide stability of the ink layer to oxidation. Preferred antioxidants include, without limitation, bis hindered phenolic sulfide or thiodiethylene bis(3,5-di-tert-butyl)-4-hydroxyhydrocinnamate (e.g. Irganox 1035 (BASF)), 2,6-di-t-butyl-4-methylphenol (BHT), MEHQ (monomethyl ether hydroquinone), and octadecyl-3-(3,5-di-tertbutyl-4-hydroxyphenyl)propionate (e.g. Irganox 1076 (BASF)). The antioxidant, if present, is used in an amount between about 0.1 pph to about 3 pph, more preferably about 0.25 pph to about 2 pph.

One preferred stabilizer is a tetrafunctional thiol, e.g., pentaerythritol tetrakis(3-mercaptopropionate) from Sigma-Aldrich (St. Louis, Mo.). The stabilizer, if present, is used in an amount between about 0.01 pph to about 1 pph, more preferably about 0.01 pph to about 0.2 pph.

Slip agents enhance wetting and flow of the ink layer composition. Slip agents include silicone polyether acrylate compounds (e.g. Tego® Rad 2250, Tego® Rad 2200, Tego® Rad 2700, Tego® Glide 432, Tego® Glide 435 (Evonik Industries). Other classes of slip agents include polyols and non-reactive surfactants such as, without limitation, the polyol Acclaim 3201 (poly(ethylene oxide-co-propylene oxide)) available from Bayer (Newtown Square, Pa.).

The present description encompasses ribbons or cables for optical communications that include two or more fibers as described herein. The ribbons or cables may be incorporated within or interface with a telecommunications system. The telecommunication system may include a transmitter, an optical communication channel coupled to the transmitter, and a receiver coupled to the optical communication channel. The transmitter includes a light source for generating an optical signal and launching the optical signal into the optical communication channel. The optical signal propagates through the optical communication channel and is directed to the receiver. The receiver detects and/or processes the optical signal. The optical signal embodies data or information. The transmitter may also encode the data or information in the form of an optical signal and the receiver may decode the optical signal to recover the data or information. The transmitter may also encrypt the data or information in the optical signal and the receiver may also decrypt the optical signal when restoring the data or information. The optical communication channel includes an optical fiber or combination of two or more optical fibers as described herein.

The ink layer or pigmented secondary composition is applied to the optical fiber as a viscous liquid and cured to form a mechanically rigid, solidified coating (referred to herein as a pigmented cured product). The pigmented cured product includes the photoreactive marking compound in an initial state having an initial fluorescence. The photoreactive marking compound is typically dispersed at a uniform concentration along the length of the optical fiber and exhibits uniform fluorescence along the length of the optical fiber.

In accordance with the present disclosure, the pigmented cured product is exposed to marking radiation having a wavelength within an absorption band of the initial state of the photoreactive marking compound capable of producing the initial fluorescence. The marking radiation has an intensity sufficient to transform the initial state of the photoreactive marking compound to a transformed state that differs in fluorescence from the initial state. Relative to the initial state, when excited at the same wavelength and same intensity as the initial state, the transformed state has no fluorescence or fluorescence that differs in intensity, line shape or wavelength from the initial fluorescence. Preferably, the transformed state exhibits no fluorescence so that the contrast between the initial state and transformed state is great.

To form marks on the optical fiber, the optical fiber is exposed to marking radiation. Marks or marked regions correspond to regions along the length of the optical fiber that have been exposed to marking radiation. Marked regions are detected by fluorescence and are distinguishable on the basis of an absence of fluorescence or fluorescence that deviates from the fluorescence of the initial state of the photoreactive marking compound. Marked regions can be formed selectively along the length of an optical fiber to provide a pattern of marks that operate as an identifier of the optical fiber.

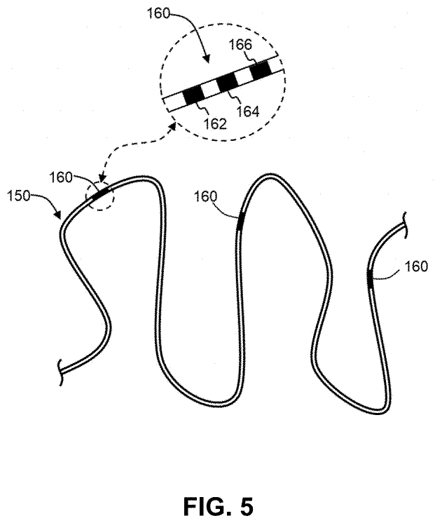

FIG. 5 shows an example of an optical fiber marked by the method described herein. Optical fiber 150 is a coated optical fiber that includes an ink layer or pigmented secondary layer with marked sections 160, each of which includes a group of marks 162, 164, and 166. Marks 162, 164, and 166 are formed by selectively exposing optical fiber 150 to marking radiation at the locations indicated. The space between marked sections 160, the space between marks 162 and 164, and the space between marks 164 and 166 constitute unmarked sections of optical fiber 150. The unmarked sections are sections that have not been intentionally exposed to marking radiation. The concentration of the transformed state of the photoreactive marking compound is higher in the marked sections than in the unmarked sections. Preferably at least 50%, or at least 60%, or at least 70%, or at least 80%, or at least 90% of the concentration of the photoreactive marking compound is in the transformed state in the marked sections and less than 20%, or less than 15%, or less than 10%, or less than 5%, or less than 1% of the concentration of the photoreactive marking compound is in the transformed state in the unmarked sections.

Although depicted in black in FIG. 5 for purposes of illustrating a contrast with the unmarked sections, marks 162, 164, and 166 are preferably not visible under ambient lighting (e.g. room light), but become detectable upon exposure to viewing radiation. Viewing radiation is electromagnetic radiation that reveals a contrast between marks of a marked section and unmarked sections of the optical fiber. The wavelength of viewing radiations is preferably a UV wavelength, such as a wavelength between 200 nm and 400 nm, or a wavelength between 250 nm and 400 nm, or a wavelength between 300 nm and 400 nm, or wavelength between 325 nm and 400 nm, or a wavelength between 350 nm and 400 nm. Upon exposure of the optical fiber to viewing radiation, sections with high fluorescence intensity (e.g. unmarked sections) are readily distinguished from sections with no or low fluorescence intensity (e.g. marked sections). The pattern of fluorescence intensity distribution constitutes a pattern of marks that provides an identifier for the optical fiber.

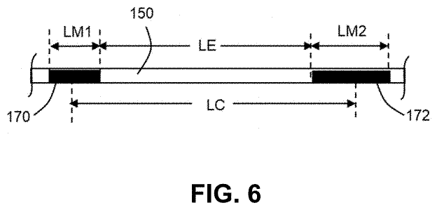

The length, width, spacing, arrangement, and grouping of marks can be varied in a multitude of ways to provide a series of distinct combinations that provide unique identifiers for each optical fiber in a ribbon, bundle, or cable. FIG. 6 shows selected features of marks that can be varied to provide different ways of marking optical fibers. In FIG. 6, a portion of optical fiber 150 is shown with marks 170 and 172. Mark 170 has mark length LM1 and mark 172 has mark length LM2. As depicted, mark lengths LM1 and LM2 differ. In other embodiments, marks lengths LM1 and LM2 are the same. Marks 170 and 172 have edge spacing LE (edge-to-edge spacing) and center spacing LC (center-to-center spacing). Any of mark length LM, edge spacing LE, and center spacing LC can be varied to provide a series of distinguishable mark patterns that can be used to identify optical fibers.

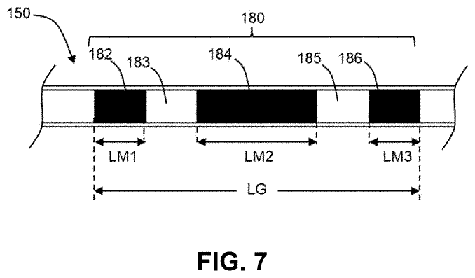

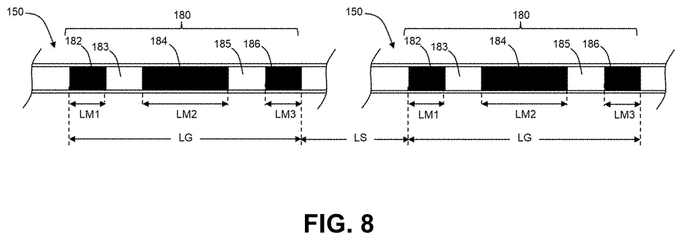

Individual marks or groups of marks can be repeated at various intervals along the length of the optical fiber to provide further ways of creating unique patterns of marks for identifying optical fibers. In FIG. 5, for example, each of marked sections 160 includes a group of three marks (162, 164, and 166) that are spaced apart at approximately equal distances (as measured along the length of the optical fiber). The marked sections 160 may be repeated along the entire length of the optical fiber, or along selected portions of the length of the optical fiber. The spacing between consecutive instances of marked sections 160 may be the same or different. FIGS. 7 and 8 show related examples. In FIG. 7, optical fiber 150 includes marked section 180 that includes a group of marks 182, 184, and 186 separated by unmarked regions 183 and 185. In FIG. 7, mark 182 is consecutive with unmarked region 183, which is consecutive with mark 184, which is consecutive with unmarked region 185, which is consecutive with mark 186. The mark lengths of marks 182, 184, and 186 are LM1, LM2, and LM3 as shown, which may be equal or unequal to each other. The edge and center spacings (not shown) for marks 182, 184, and 186 may also equal or unequal to each other. The length of marked section 180 is referred to as group length and is denoted as LG. FIG. 8 shows an optical fiber 150 having repeated instances of marked section 180, where the spacing between marked sections 180 is denoted as LS. In a preferred embodiment, LS>LG.

The number of marks in a group of marks defining a marked section is one or more, or two or more, or three or more, or four or more, or five or more, or ten or more. The mark length LM is 1 mm or greater, or 2 mm or greater, or 4 mm or greater, or 8 mm or greater, or 10 mm or greater, or 20 mm or greater, or in the range from 1 mm to 100 mm, or in the range from 2 mm to 50 mm, or in the range from 3 mm to 30 mm, or in the range from 4 mm to 20 mm, or in the range from 1 mm to 10 mm, or in the range from 1 mm to 5 mm. The mark length of marks within a group or in different groups may be equal or unequal. The edge spacing LE is 1 mm or greater, or 2 mm or greater, or 4 mm or greater, or 8 mm or greater, or 10 mm or greater, or 20 mm or greater, or in the range from 1 mm to 100 mm, or in the range from 2 mm to 50 mm, or in the range from 3 mm to 30 mm, or in the range from 4 mm to 20 mm, or in the range from 1 mm to 10 mm, or in the range from 1 mm to 5 mm. The center spacing LC is 2 mm or greater, or 4 mm or greater, or 8 mm or greater, or 10 mm or greater, or 20 mm or greater, or in the range from 2 mm to 100 mm, or in the range from 2 mm to 50 mm, or in the range from 3 mm to 30 mm, or in the range from 4 mm to 20 mm. The group spacing LS is 2 mm or greater, or 10 mm or greater, or 25 mm or greater, or 50 mm or greater, or 100 mm or greater, or in the range from 2 mm to 10 m, or in the range from 10 mm to 5 m, or in the range from 25 mm to 3 m, or in the range from 50 mm to 2 m.

Marks or groups of marks are distributed along the entire length of an optical fiber or over selected portions of an optical fiber. The distribution of marks or groups of marks is periodic or aperiodic. The marks are configured as linear features (e.g. stripes, dots, dashes) along the length of the optical fiber. The marks have a width transverse to the axis defined by the length of the optical fiber (referred to herein as the central axis of the fiber). The width extends for a distance corresponding to a fraction of the circumference of the outer surface of the coating of the optical fiber. In embodiments, the width of a mark is at least 1%, or at least 5%, or at least 10%, or at least 25%, or at least 50% of the circumference of the outer surface of the coating of the optical fiber. In some embodiments, the marks extend around the full circumference of the outer surface of the coating of the optical fiber and form ring-shaped features.

In addition to physical distances (mark length, mark width, edge spacing, center spacing, group spacing etc.), marks or groups of marks can be distinguished on the basis of fluorescence intensity or fluorescence wavelength. The photoreactive marking compound has an initial state with an initial fluorescence and transforms to a transformed state having a transformed fluorescence that differs from the initial fluorescence. In a preferred embodiment, the fluorescence intensity of the initial state is greater than the fluorescence intensity of the transformed state (when excited under common conditions, e.g. under the same viewing radiation). In another preferred embodiment, the fluorescence intensity of the transformed state is essentially zero. The transformation of the photoreactive marking compound in a mark is complete or partially complete. When the transformation is partially complete, a fraction of the initial concentration of the initial state of the photoreactive marking compound remains and fluorescence from the remaining fraction of the initial state of the photoreactive marking compound is detected at reduced intensity by the viewing radiation. By controlling the fraction of the initial concentration of the initial state of the photoreactive marking compound that is transformed by the marking radiation, the fluorescence intensity of the mark can be controlled with high precision. In embodiments in which the transformed state of the photoreactive marking compound exhibits no fluorescence under the viewing radiation, the fluorescence of a mark can be varied essentially continuously between the initial fluorescence intensity and zero fluorescence intensity.

The source of marking radiation needs to provide radiation with sufficient intensity to convert the initial state of the photoreactive marking compound to the transformed state. Preferred sources of the marking radiation include lasers and LEDs (light emitting diodes). A preferred wavelength of the marking radiation is a UV or a blue wavelength, such as a wavelength between 200 nm and 420 nm, or a wavelength between 250 nm and 420 nm, or a wavelength between 300 nm and 420 nm, or wavelength between 325 nm and 420 nm, or a wavelength between 350 nm and 420 nm. Other preferred blue wavelengths are wavelengths between 410 nm and 450 nm, or wavelengths between 420 nm and 440 nm. Preferred photoreactive marking compounds have an absorption band that includes a UV wavelength provided by the source of marking radiation and a fluorescence produced upon excitation of the absorption band that includes a wavelength in the visible. In other embodiments, the wavelength of the marking radiation is an infrared wavelength and the initial state of the photoreactive reactive marking compound is converted to the transformed state by a non-linear optical (e.g. multiphoton absorption) process. Preferred infrared wavelengths include a wavelength between 900 nm and 1500 nm, or a wavelength between 950 nm and 1400 nm, or a wavelength between 1000 nm and 1300 nm, or a wavelength between 1050 nm and 1250 nm.

The intensity required to convert the photoreactive marking compound from the initial state to the transformed state depends on the wavelength of the marking radiation, intensity of the excited absorption band of the initial state of the photoreactive marking compound, and potential competing absorption from other components (e.g. pigments) present in the pigmented cured product. Through routine experimentation of adjusting the intensity or power of the source of marking radiation, one of skill in the art can determine a critical intensity threshold at which transformation of the photoreactive marking compound occurs.

The mark length LM, edge spacing LE, center spacing LC, group spacing LG, number of marks in a group, and number of marked sections can be controlled by controlling the duration and timing of exposure of the optical fiber to the marking radiation. The source of marking radiation, for example, can be selectively turned on and off to control the duration and timing of the exposure of the optical fiber to the marking radiation. The source of marking radiation can be pulsed or modulated to control the duration of exposure. The source of marking radiation and the optical fiber can be fixed in position relative to each other as the marking radiation is applied or in relative motion as the marking radiation is applied. For example, the source of marking radiation can be scanned along the length of an optical fiber or the optical fiber can be in motion as the marking radiation is applied. Motion of the source of marking radiation is achieved by integrating it with a motion stage (e.g. a mounting frame configured for motion in the x-, y-, and or z-directions). Motion of an optical fiber is achieved by routing the optical fiber through a series of pulleys, reels, spools, or capstans and conveying the optical fiber through the field of electromagnetic radiation delivered by the source of marking radiation.

A longer time of exposure leads to greater conversion of the photoreactive marking compound from the initial state to the transformed state and a greater contrast in fluorescence of marked sections and unmarked sections of the optical fiber. Increasing the intensity of the marking radiation by increasing the power of the source of marking radiation or focusing the marking radiation is another method of controlling the fraction of the concentration of the photoreactive marking compound that is converted from the initial state to the transformed state. When the optical fiber and source of marking radiation are in motion relative to each other, a longer exposure time leads to greater mark lengths. When the optical fiber and source of marking radiation are in motion relative to each other, the source of marking radiation can be selectively turned on or off to control the portions along the length of the optical fiber that are exposed to the marking radiation as well as edge spacing LE, center spacing LC, and group spacing LG.

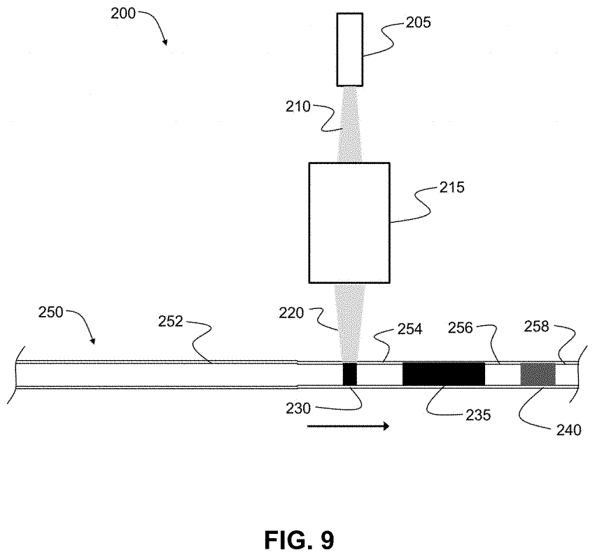

A schematic optical system for forming marks is shown in FIG. 9. Optical system 200 includes a source 205 of marking radiation, which provides a beam of electromagnetic radiation 210 that is directed to optical system 215. Optical system 215 provides marking radiation 220 that is used to form marks 230, 235, and 240 on optical fiber 250, which is moving in the direction of the arrow relative to source 205 and optical system 215. Optical system 215 includes optical elements that focus the beam of electromagnetic radiation 210 to form marking radiation 220. Marking radiation 220 is configured as a point focus or line focus and is directed to optical fiber 250 to form marks. Optics included within optical system 215 include lenses (collimating lenses, focusing lenses), lens assemblies (e.g. telescope), mirrors, axicons, beam splitters etc. Spherical lenses provide point focusing of marking radiation 220. Aspherical lenses, cylindrical lenses, and axicons provide line focusing of marking radiation 220. In one embodiment, the line focus is aligned along the length of the optical fiber 250. Optical fiber 250 is positioned at or near the focusing point of optical system 215. In other embodiments, source 205 provides marking radiation directly without processing by an optical system. Source 205 is preferably a laser or LED that emits one or more UV wavelengths or one or more wavelengths in the range from 400 nm-450 nm.

Optical fiber 250 includes unmarked portions 252, 254, 256, and 258. Unmarked portion 252 corresponds to the portion of optical fiber 250 that has yet to pass by optical system 215. Unmarked portions 254, 256, and 258 correspond to portions of optical fiber 250 that passed optical system 215 when marking radiation 220 was absent (e.g. marking radiation 220 was blocked or source 205 was cycled off as unmarked portions 254, 256 and 258 passed). The mark length is controlled by the length of time that the optical fiber 250 is exposed to marking radiation 220 as it passes by optical system 215. A longer time of exposure leads to a longer mark. Marks 230 and 235 show a greater contrast to unmarked portion 252 than does mark 240 due to a lower conversion of the photoreactive marking compound to the transformed state in mark 240 relative to marks 230 and 235. Such a result can be achieved, for example, by attenuating marking radiation 220 or reducing the power of source 205 as portion 240 passes by optical system 215. In FIG. 9, unmarked portion 252 is consecutive with mark 230, which is consecutive with unmarked portion 254, which is consecutive with mark 235, which is consecutive with unmarked portion 256, which is consecutive with mark 240, which is consecutive with unmarked portion 258.

### EXAMPLES

A series of ink layer compositions was formulated and cured to form film samples on glass substrates. The components of the ink layer compositions are summarized in Table 1. Concentrations are listed in weight percent (wt %) or parts per hundred (pph) as indicated.

TABLE 1

| Component | White | Black | Brown | Blue |
|---|---|---|---|---|
| Miramer PE210 (wt %) | 30.0 | 30.0 | 30.0 | 30.0 |
| Miramer M240 (wt %) | 51.33 | 52.5 | 47.65 | 49.6 |
| NYC (wt %) | 5.0 | 5.0 | 5.0 | 5.0 |
| TPO (wt %) | 3.0 | 3.0 | 3.0 | 3.0 |
| Irgacure 184 (wt %) | 2.0 | 2.0 | 2.0 | 2.0 |
| Uvitex ® OB (pph) | 0.1 | 0.1 | 0.1 | 0.1 |
| Irganox 1035 (pph) | 0.5 | 0.5 | 0.5 | 0.5 |
| Tegorad 2250 (pph) | 3.25 | 3.25 | 3.25 | 3.25 |
| White Dispersion (wt %) | 8.67 | 0 | 1.95 | 2.6 |
| Black Dispersion (wt %) | 0 | 7.5 | 0 | 0 |
| Blue Dispersion (wt %) | 0 | 0 | 0 | 7.8 |
| Violet Dispersion (wt %) | 0 | 0 | 2.6 | 0 |
| Orange Dispersion (wt %) | 0 | 0 | 7.8 | 0 |

Miramer PE210 (an oligomer) is bisphenol A epoxy diacrylate (Miwon), Miramer M240 (a monomer) is ethoxylated(4) bisphenol A diacrylate (Miwon), NVC (a monomer) is N-vinylcaprolactam (Aldrich), TPO (a photoinitiator) is 2,4,6-trimethylbenzoyl diphenylphosphine oxide (BASF), Irgacure 184 (a photoinitiator) is 1-hydroxycyclohexyl-phenyl ketone (BASF), Uvitex® OB (a photoreactive marking compound) is 2,2′-(2,5-thiophenediyl) bis[5-tert-butylbenzoxazole] (BASF), Irganox 1035 (an antioxidant) is thiodiethylene bis[3-(3,5-di-tert-butyl-4-hydroxyphenyl)propionate] (BASF), Tegorad 2250 (a slip agent) is a silicone polyether acrylate compound with a proprietary composition (Evonik Industries).

The balance of the ink layer compositions consisted of pigment dispersions having the colors listed Table 1. All pigment dispersions were obtained from Penn Color, Inc. (Doylestown, Pa.). The product numbers for the dispersions are as follows: white dispersion (9W892), black dispersion (9B385), blue dispersion (9S1875), violet dispersion (9S949D), and orange dispersion (9Y804).

The ink compositions were prepared by mixing all components except for the pigment dispersion at 65° C. in a jacketed beaker. Mixing was continued until all solid components were dissolved and a homogeneous mixture was obtained. The homogeneous mixture was filtered to a level of 1 μm absolute. The required amount of pigment dispersion(s) was added to the filtered mixture and blended with a high-speed mixer for approximately 30 minutes to obtain the ink layer composition.

Films from the ink layer compositions were formed on glass plates (2-inch square) using the following procedure. Wet films were cast on glass plates with the aid of a draw-down box having an about 0.005″ gap thickness. Films were cured with 1.2 J/cm² UV dose (measured over a wavelength range of 225-424 nm by a Light Bug model IL490 from International Light) by a Fusion Systems UV curing apparatus with a 600 W/in D-bulb (50% Power and approximately 12 ft/min belt speed) to yield ink layers in film form. Cured film thickness was between about 0.003″ and 0.004″.

The source of marking radiation used in the experiments was a Q-switched Hippo laser (Spectra Physics). The marking radiation had a wavelength of 355 nm and was delivered as 10 ns pulses with a repetition rate of 80 kHz. The average power was varied between 0.2 W and 0.4 W. Marks were formed in selected regions of the ink films by rastering at a specified scan speed. The laser beam was focused to a spot size of 10 μm-20 μm on the surface of the ink film and was scanned at 20 mm/s-100 mm/s using a laser scanner (ScanLab). A rectangular area of the ink film was processed by scanning the laser back and forth along a series of parallel lines spaced apart by 20 μm-200 μm.

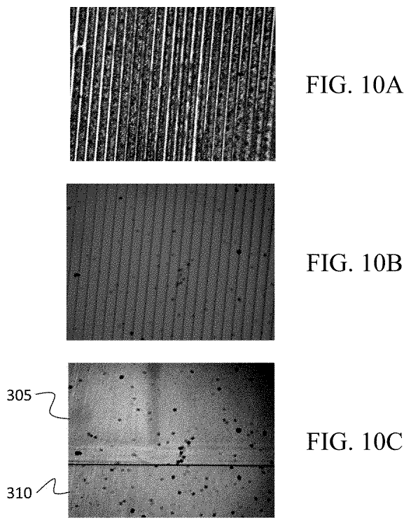

FIGS. 10A-10C show a series of magnified grayscale images of regions of a white ink film processed at different laser powers and scan rates. The image of FIG. 10A was scanned at high laser power at a scan rate of 20 mm/s and a spacing between lines of 50 μm. The observation of ridge lines is indicative to surface damage resulting from the high laser power and slow scan rate. The laser power used for the image of FIG. 10B was the same as used for the image of FIG. 10A, but the scan rate was increased to 50 mm/s. The faster scan speed leads to a shorter exposure time for each position scanned on the surface. Less surface damage was observed. The image of FIG. 10C includes upper portion 305 and lower portion 310. Upper portion 305 was treated with the laser at a low laser power (still sufficient to form marks) and a scan rate of 50 mm/s. The lower portion 310 was not treated with the laser. The similarity in appearance of upper portion 305 and lower portion 310 indicates that proper adjustment of the laser power permits formation of marks without damage to the surface. Similar results were obtained for ink film samples colored black, blue, and brown. In the results that follow, the laser power was maintained at a level sufficient to form marks, but low enough to prevent damage to the surface.

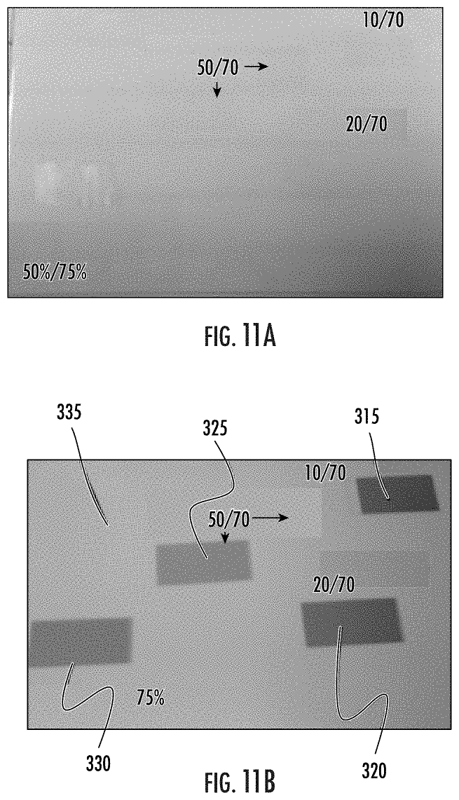

FIGS. 11A and 11B show grayscale images of a white ink film after marking with the marking radiation at 355 nm. The image shown in FIG. 11A shows the appearance of the film when viewed under ambient lighting conditions. No visible distinction between marked and unmarked regions is evident in the image of FIG. 11A. The image shown in FIG. 11B was obtained with viewing radiation provided by an LED operating at a wavelength of 395 nm. The image of FIG. 11B shows marked regions 315, 320, 325, and 330 within unmarked region 335. The bright appearance of unmarked region 335 reflects the high fluorescence intensity excited by the viewing radiation. The marks have a dark appearance, which indicates a lack of fluorescence due to conversion of the photoreactive marking compound to a low or non-fluorescent transformed state by the marking radiation. Good contrast between the marked and unmarked regions was observed.

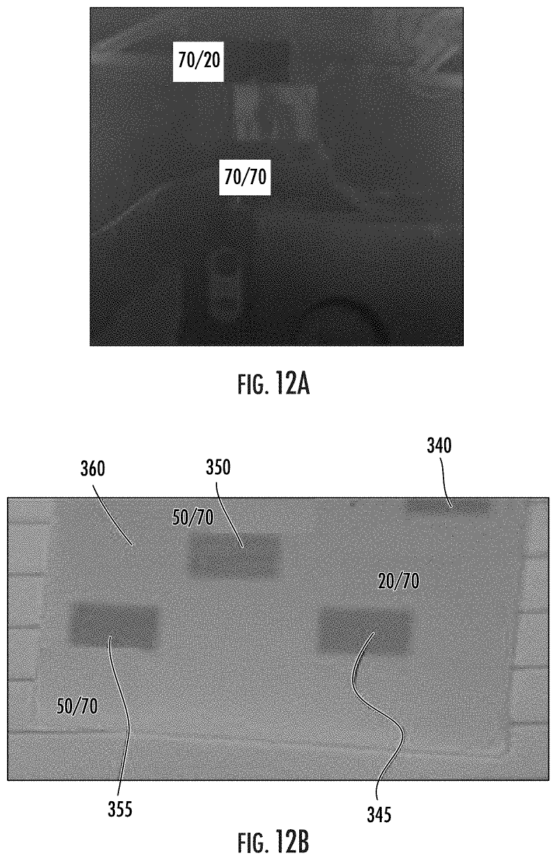

FIGS. 12A and 12B show grayscale images of a blue ink film after marking with the marking radiation at 355 nm. The image shown in FIG. 12A shows the appearance of the film when viewed under ambient lighting conditions. No visible distinction between marked and unmarked regions is evident in the image of FIG. 12A. The image shown in FIG. 12B was obtained with viewing radiation provided by an LED operating at a wavelength of 395 nm. The image of FIG. 12B shows marked regions 340, 345, 350, and 355 within unmarked region 360. The bright appearance of unmarked region 360 reflects the high fluorescence intensity excited by the viewing radiation. The marks have a dark appearance, which indicates a lack of fluorescence due to conversion of the photoreactive marking compound to a low or non-fluorescent transformed state by the marking radiation. Good contrast between the marked and unmarked regions was observed.

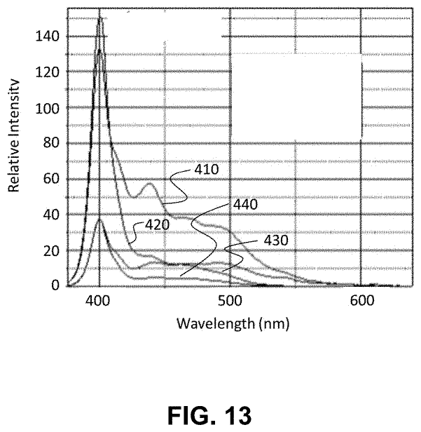

FIG. 13 shows fluorescence spectra of the photoreactive marking compound of white and blue ink films before and after exposure to marking radiation. The fluorescence spectra were excited with an LED operating at 395 nm. The intense fluorescence peak near 400 nm is stray light from the excitation source. The balance of the fluorescence spectra is attributable to fluorescence from the photoreactive marking compound. Fluorescence spectrum 410 is the fluorescence spectrum of the photoreactive marking compound in the white ink film before exposure to marking radiation. Fluorescence spectrum 420 is the fluorescence spectrum of the photoreactive marking compound in the white ink film after exposure to marking radiation. A pronounced decrease in fluorescence intensity was observed upon exposure of the white ink film to the marking radiation. Fluorescence spectrum 430 is the fluorescence spectrum of the photoreactive marking compound in the blue ink film before exposure to marking radiation. Fluorescence spectrum 440 is the fluorescence spectrum of the photoreactive marking compound in the blue ink film after exposure to marking radiation. A pronounced decrease in fluorescence intensity was observed upon exposure of the blue ink film to the marking radiation. The fluorescence from the blue ink film was lower than the fluorescence from the white ink film due to competing absorption from the blue pigment in the blue ink film.

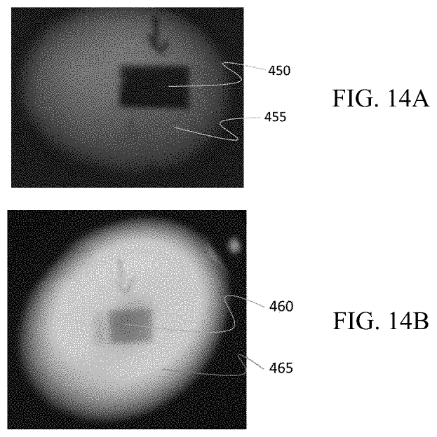

FIGS. 14A and 14B show grayscale images of marks formed by the marking radiation at 355 nm in black and brown ink films, respectively, under viewing radiation at 395 nm. The black ink film includes marked region 450 within unmarked region 455. The brown ink film includes marked region 460 within unmarked region 465. The contrast between marked and unmarked regions is evident in both black and brown ink films. Appreciable contrast was also observed in ink films having red, green, yellow, slate, rose, aqua, violet, and orange colors.

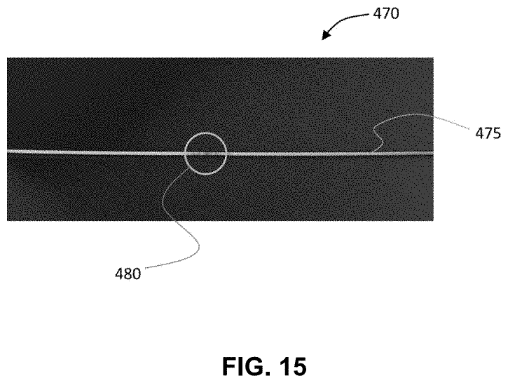

FIG. 15 shows a grayscale image of an optical fiber marked in accordance with the present disclosure upon viewing with viewing radiation with a wavelength of 395 nm. Optical fiber 470 included a coating with an outer layer containing a photoreactive marking compound and a blue pigment. The outer layer had an outer diameter of about 240 μm. Optical fiber 475 includes unmarked portion 475 exhibiting high fluorescence intensity from the photoreactive marking compound and a marked region, encircled at 480, exhibiting low fluorescence intensity from the photoreactive marking compound.

Although illustrated for compositions suited for use as ink layers and pigmented secondary layers for optical fibers, the methods described herein are applicable generally to films, coatings, and articles containing a photoreactive marking compound. Curable compositions containing monomers for forming plastics and polymers are widely used to provide materials and coatings for commercial products. Inclusion of a photoreactive compound in a curable composition leads to incorporation of the photoreactive compound in the cured product of the composition. The state of the photoreactive compound can be transformed at selected positions of the cured product to provide marking or labelling of the cured product for identification or other purposes. Since, as noted herein, the mark is not detectable under normal ambient light, the presence of the mark is not apparent and does not detract from the appearance or functionality of the cured product. When viewed under viewing radiation, the mark is apparent and serves as an identifier of the cured product. The arrangement of marks can further be configured or patterned to form letters, words, symbols, numbers, logos, and trademarks on cured products. Most plastics and polymers capable of being cured thermally or with radiation can be marked or labeled with the methods described herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the illustrated embodiments. Since modifications, combinations, sub-combinations and variations of the disclosed embodiments that incorporate the spirit and substance of the illustrated embodiments may occur to persons skilled in the art, the description should be construed to include everything within the scope of the appended claims and their equivalents.

What is claimed is:

1. A method of marking an optical fiber, comprising:
exposing a first section of the optical fiber to a marking radiation, the optical fiber comprising a glass fiber surrounded by a coating comprising a first layer, the first layer comprising a pigment and a photoreactive marking compound, the photoreactive marking compound having a first state and a second state, the second state differing in fluorescence from the first state when excited with a viewing radiation, the marking radiation transforming the photoreactive marking compound from the first state to the second state to form a mark on the first section of the optical fiber.

2. The method of claim 1, wherein the optical fiber is in motion when exposed to the marking radiation.

3. The method of claim 1, wherein the marking radiation has a wavelength between 200 nm and 420 nm.

4. The method of claim 1, wherein the marking radiation is provided by a source of electromagnetic radiation, the source of electromagnetic radiation comprising a laser or an LED (light emitting diode).

5. The method of claim 4, wherein a power of the source of electromagnetic radiation is varied when the optical fiber is exposed to the marking radiation.

6. The method of claim 1, wherein the pigment exhibits no visible fluorescence when excited by the viewing radiation.

7. The method of claim 1, wherein the first state fluoresces in the visible when excited by the viewing radiation.

8. The method of claim 1, wherein the second state has no visible fluorescence when excited by the viewing radiation.

9. The method of claim 1, wherein the viewing radiation comprises a UV (ultraviolet) wavelength.

10. The method of claim 1, further comprising exposing a second section of the optical fiber to the marking radiation to form a second mark on the optical fiber, wherein the first mark and the second mark are separated by a first unmarked section of the optical fiber.

11. The method of claim 10, further comprising exposing a third section of the optical fiber to the marking radiation to form a third mark on the optical fiber, wherein the third mark and the second mark are separated by a second unmarked section of the optical fiber.

12. The method of claim 1, wherein the transforming the photoreactive marking compound from the first state to the second state comprises a structural rearrangement, a photochemical reaction or a decomposition of the photoreactive marking compound.

13. An optical fiber comprising:
a glass fiber surrounded by a coating, the coating comprising:
a first layer, the first layer comprising a pigment and a photoreactive marking compound, the photoreactive marking compound having a first state and a second state, the second state differing in fluorescence from the first state when excited with a viewing radiation, the first layer including a first section and a second section, the first section having a first concentration of the first state of the photoreactive marking compound and the second section having a second concentration of the first state of the photoreactive marking compound, the first concentration differing from the second concentration.

14. The optical fiber of claim 13, wherein the first state fluoresces in the visible when excited by the viewing radiation.

15. The optical fiber of claim 14, wherein the second state has no visible fluorescence when excited by the viewing radiation.

16. The optical fiber of claim 13, wherein at least 70% of the photoreactive marking compound is in the second state in the first section and less than 20% of the photoreactive marking compound is in the second state in the second section.

17. The optical fiber of claim 13, wherein the second section is consecutive with the first section.

18. A method of marking an article, comprising:
exposing a first section of the article to a marking radiation, the article comprising a photoreactive marking compound, the photoreactive marking compound having a first state and a second state, the second state differing in fluorescence from the first state when excited with a viewing radiation, the marking radiation transforming the photoreactive marking compound from the first state to the second state to form a mark on the first section of the article.

19. The method of claim 18, wherein the marking radiation has a wavelength between 200 nm and 400 nm.

20. The method of claim 18, wherein the first state fluoresces in the visible when excited by the viewing radiation.

21. The method of claim 18, wherein the second state has no visible fluorescence when excited by the viewing radiation.

22. The method of claim 18, wherein the viewing radiation comprises a UV (ultraviolet) wavelength.
